(19) United States
(12) Patent Application Publication
(10) Pub. No.: US 2022/0351428 A1
(43) Pub. Date: Nov. 3, 2022

(54) INFORMATION PROCESSING APPARATUS, INFORMATION PROCESSING METHOD, AND COMPUTER READABLE RECORDING MEDIUM

(71) Applicant: OLYMPUS CORPORATION, Tokyo (JP)

(72) Inventor: Kazuhito HORIUCHI, Tokyo (JP)

(73) Assignee: OLYMPUS CORPORATION, Tokyo (JP)

(21) Appl. No.: 17/861,480

(22) Filed: Jul. 11, 2022

Related U.S. Application Data
(63) Continuation of application No. PCT/JP2020/001563, filed on Jan. 17, 2020.

(51) Int. Cl. G06T 11/00; G02B 21/36

(52) U.S. Cl. CPC G06T 11/00; G02B 21/365; G06T 2210/41

(57) ABSTRACT

An information processing apparatus include a processor configured to: control a display to display at least a partial image of a captured image generated by capturing an image of an observation target; generate field of view information by associating: display position information indicating a position of a display area corresponding to the displayed partial image; magnification information indicating a display magnification of the partial image; and time information indicating a display time of the partial image; record the field of view information in a memory; and extract a piece of the field of view information including the magnification information indicating at least a single kind of specific display magnification input to an input device from among pieces of the field of view information recorded in the memory; generate a field of view map image corresponding to the extracted piece of field of view information; and control the display to display the field of view map image.

This application is a continuation of International Application No. PCT/JP2020/001563, filed on Jan. 17, 2020, the entire contents of which are incorporated herein by reference.

### BACKGROUND

The present disclosure relates to an information processing apparatus, an information processing method, and a computer readable recording medium.

In the related art, a medical system that records an observation result, such as presence or absence of a medical abnormality in a medical image or a comment on the medical abnormality, and observation progress information on the medical image in a database in an associated manner (for example, see Japanese Laid-open Patent Publication No. 2004-267273).

### SUMMARY

According to one aspect of the present disclosure, there is provided an information processing apparatus including a processor including hardware, the processor being configured to: control a display to display at least a partial image of a captured image generated by capturing an image of an observation target; generate field of view information by associating: display position information indicating a position of a display area corresponding to the displayed partial image; magnification information indicating a display magnification of the partial image; and time information indicating a display time of the partial image; record the field of view information in a memory; and extract a piece of the field of view information including the magnification information indicating at least a single kind of specific display magnification input to an input device from among pieces of the field of view information recorded in the memory; generate a field of view map image corresponding to the extracted piece of field of view information; and control the display to display the field of view map image.

### BRIEF DESCRIPTION OF THE DRAWINGS

FIG. 1 is a block diagram illustrating an information processing system according to a first embodiment;

FIG. 2 is a flowchart illustrating an information processing method;

FIG. 3 is a diagram for explaining field of view information;

FIG. 4 is a diagram for explaining the field of view information;

FIG. 5 is a diagram for explaining a field of view map image;

FIG. 6 is a diagram for explaining the field of view map image;

FIG. 7 is a diagram for explaining a first display mode;

FIG. 8 is a diagram for explaining a second display mode;

FIG. 9 is a block diagram illustrating an information processing system according to a second embodiment;

FIG. 10 is a flowchart illustrating an information processing method;

FIG. 11 is a diagram for explaining Step S10A;

FIG. 12 is a diagram for explaining Step S10A;

FIG. 13 is a diagram for explaining Step S10A;

FIG. 14 is a block diagram illustrating an information processing system according to a third embodiment;

FIG. 15 is a flowchart illustrating an information processing method;

FIG. 16 is a diagram for explaining Step S19;

FIG. 17 is a diagram for explaining Step S20;

FIG. 18 is a diagram for explaining Step S21; and

FIG. 19 is a block diagram illustrating a microscope system according to a fourth embodiment.

### DETAILED DESCRIPTION

Modes (hereinafter, referred to as “embodiments”) for carrying out the present disclosure will be described below with reference to the drawings. The present disclosure is not limited by the embodiments below. Further, in description of the drawings, the same components are denoted by the same reference symbols.

### First Embodiment

Configuration of Information Processing System

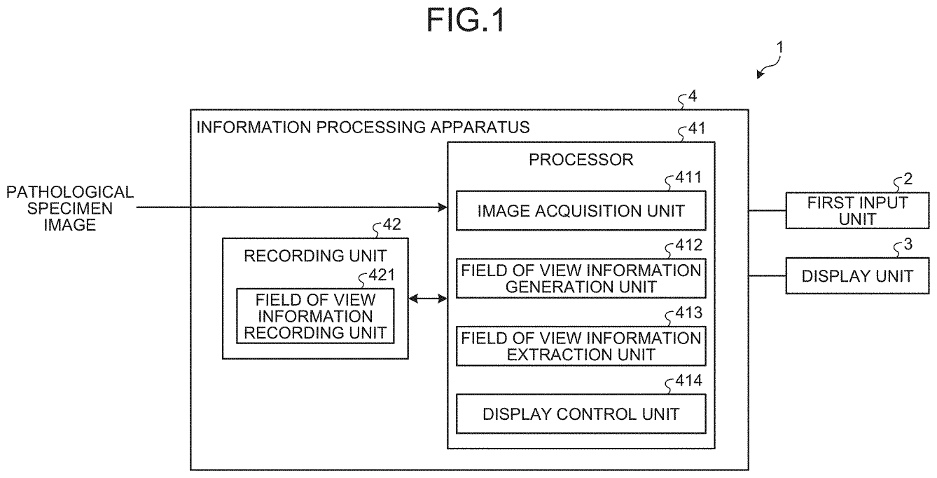

FIG. 1 is a block diagram illustrating an information processing system 1 according to a first embodiment.

The information processing system 1 is a system that performs various processes on a pathological specimen image that is acquired externally, and displays an image corresponding to the pathological specimen image. The pathological specimen image corresponds to a captured image according to the present disclosure.

Here, in the first embodiment, the pathological specimen image is an image (virtual slide image) of an entire specimen with wide field of view and high resolution, where the image is obtained by dividing a range of a pathological specimen into small sections, capturing images of portions of the pathological specimen corresponding to the small sections by using a high-resolution objective lens, and merging the captured images. The pathological specimen corresponds to an observation target according to the present disclosure. Further, the pathological specimen image is recorded in advance in an external server or the like.

The information processing system 1 includes, as illustrated in FIG. 1, a first input unit 2, a display unit 3, and an information processing apparatus 4.

The first input unit 2 corresponds to an input unit according to the present disclosure. The first input unit 2 is configured with various input devices, such as a keyboard, a mouse, a touch panel, or various switches, and receives input operation performed by a user. In the first embodiment, the input operation includes observation start operation, display position change operation, display magnification change operation, observation termination operation, selection condition input operation, and display mode selection operation as described below.

The observation start operation is operation of starting to perform observation (display) of an acquired pathological specimen image.

The display position change operation is operation of changing a position of an area to be displayed (hereinafter, described as a display area) in the entire pathological specimen image.

The display magnification change operation is operation of changing a size of the display area.

The observation termination operation is operation of terminating observation (display) of the acquired pathological specimen image.

The selection condition input operation is operation of inputting a selection condition for extracting a specific piece of field of view information from all pieces of field of view information that are recorded in a recording unit 42. In the first embodiment, the selection condition is at least one kind of a display magnification. Meanwhile, the field of view information and the display magnification will be described in detail in explanation of an “information processing method” to be described later.

The display mode selection operation is operation of selecting a display mode of a field of view map image that is generated by a processor 41. The display mode includes a first display mode for displaying a superimposed image in which the field of view map image is superimposed on the pathological specimen image, and a second display mode in which the field of view map image and the pathological specimen image are displayed side by side. In other words, the display mode selection operation is operation of selecting any of the first display mode and the second display mode. Meanwhile, the field of view map image will be described in detail in explanation of the “information processing method” to be described later.

Further, the first input unit 2 outputs a signal corresponding to the input operation to the information processing apparatus 4.

The display unit 3 is implemented by a display device, such as a liquid crystal display (LCD) or an electro luminescence (EL) display, and displays various images based on a display signal that is output from the information processing apparatus 4.

The information processing apparatus 4 is configured with, for example, a personal computer (PC), and performs various processes on the pathological specimen image that is acquired externally. The information processing apparatus 4 includes, as illustrated in FIG. 1, the processor 41 and the recording unit 42.

The processor 41 is configured with, for example, a general-purpose processor, such as a central processing unit (CPU), an application specific integrated circuit (ASIC), a field programmable gate array (FPGA), or the like. The processor 41 includes, as illustrated in FIG. 1, an image acquisition unit 411, a field of view information generation unit 412, a field of view information extraction unit 413, and a display control unit 414. Meanwhile, functions of the processor 41 (the image acquisition unit 411, the field of view information generation unit 412, the field of view information extraction unit 413, and the display control unit 414) will be described in detail in explanation of the “information processing method” to be described later.

The recording unit 42 is configured by using various IC memories, such as a read only memory (ROM), e.g., a flash memory, capable of performing recording in an updated manner or a random access memory (RAM), by using a hard disk that is incorporated in the apparatus or connected by a data communication terminal, or by using an information recording device, such as a compact disk-ROM (CD-ROM), and a certain device for reading and writing information with respect to the information recording device. Further, the recording unit 42 records therein a program to be executed by the processor 41 and various kinds of data (including the field of view information). Meanwhile, a field of view information recording unit 421 included in the recording unit 42 is a part for recording the field of view information.

Information Processing Method

The information processing method performed by the information processing apparatus 4 as described above will be described below.

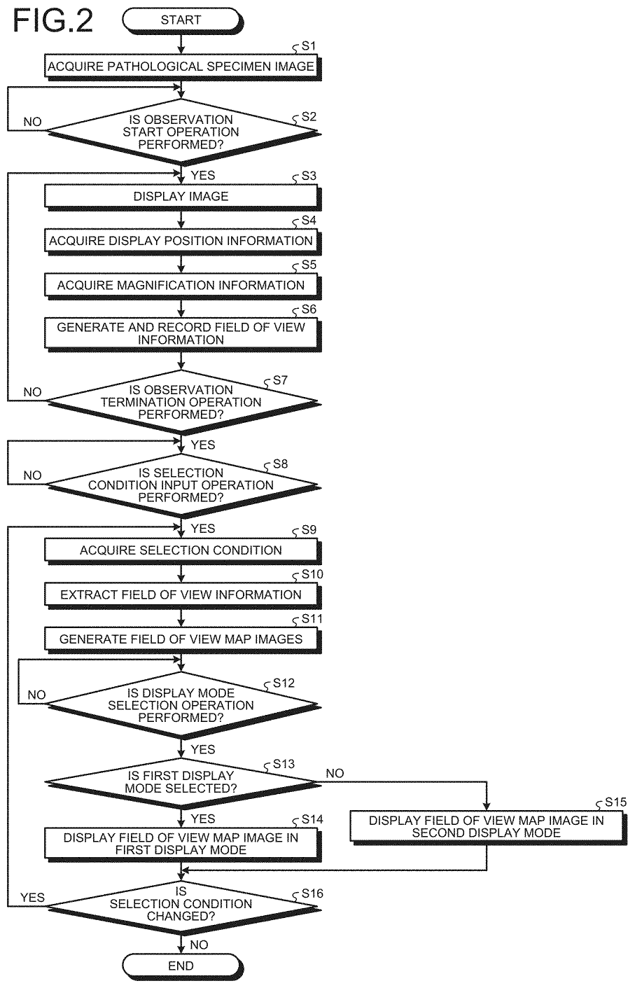

FIG. 2 is a flowchart illustrating the information processing method.

First, the image acquisition unit 411 acquires a pathological specimen image via a network (not illustrated) (Step S1).

After Step S1, the processor 41 constantly monitors whether the observation start operation is performed on the first input unit 2 by a user (Step S2).

If it is determined that the observation start operation is performed (Step S2: Yes), the display control unit 414 controls operation of the display unit 3 and causes the display unit 3 to display an image in a display area that is identified by the display position change operation and the display magnification change operation that are performed on the first input unit 2 by the user in the entire area of the pathological specimen image (Step S3).

Further, at almost the same time as Step S3, the field of view information generation unit 412 acquires display position information indicating a display position in the image that is displayed by the display unit 3 at Step S3, based on the display position change operation that is performed on the first input unit 2 by the user (Step S4).

Here, the display position in the image indicates coordinate values (X coordinate and Y coordinate) of a central position of the image when a single point in the pathological specimen image is adopted as an origin.

Furthermore, at almost the same time as Step S3, the field of view information generation unit 412 acquires magnification information indicating a display magnification of the image that is displayed by the display unit 3 at Step S3, based on the display magnification change operation that is performed on the first input unit 2 by the user (Step S5).

Here, the display magnification of the image indicates a ratio of enlargement from the pathological specimen image to the image.

After Steps S4 and S5, the field of view information generation unit 412 generates the field of view information by associating the display position information and the magnification information that are acquired at Steps S4 and S5 with time information indicating a display time at which the image corresponding to the display position information and the magnification information is displayed on the display unit 3. Then, the field of view information generation unit 412 records the generated field of view information in the field of view information recording unit 421 (Step S6).

After Step S6, the processor 41 constantly monitors whether the observation termination operation is performed on the first input unit 2 by the user (Step S7).

If it is determined that the observation termination operation is not performed (Step S7: No), the processor 41 returns to Step S3.

While the processes from Steps S3 to S6 are repeated, the display position and the size of the image that is displayed by the display unit 3 at Step S3 are sequentially changed in accordance with the display position change operation and the display magnification change operation that are performed on the first input unit 2 by the user. Further, pieces of the field of view information are sequentially recorded in the field of view information recording unit 421.

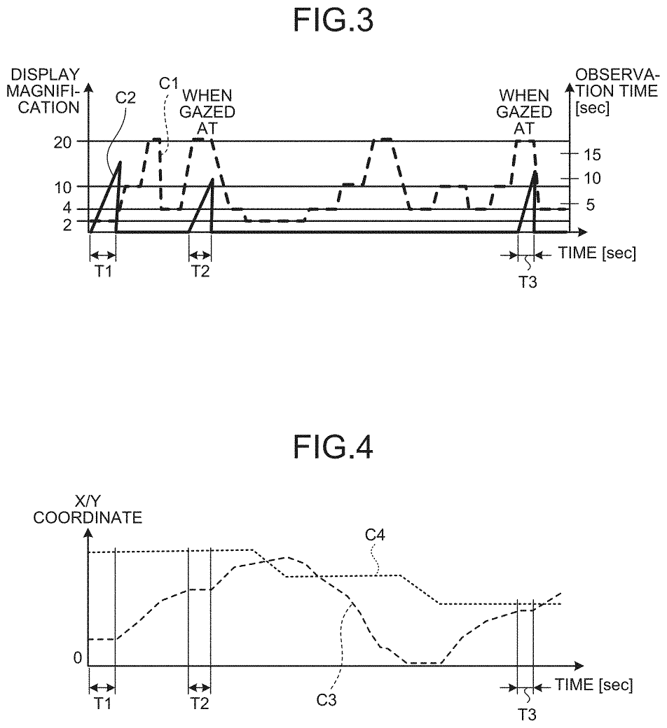

FIG. 3 and FIG. 4 are diagrams for explaining the field of view information. Specifically, a bold dashed line C1 illustrated in FIG. 3 represents a temporal change of the display magnification that represents the magnification information. Further, a bold solid line C2 illustrated in FIG. 3 represents an observation time during which an image of the same display area is continuously displayed, that is, the observation time of the user. Furthermore, a dashed line C3 illustrated in FIG. 4 represents a temporal change of the X coordinate at the display position that represents the display position information. Moreover, a dashed line C4 illustrated in FIG. 4 represents a temporal change of the Y coordinate at the display position that represents the display position information.

In the first embodiment, as indicated by the bold dashed line C1 in FIG. 3, the display magnification is changed to two times, four times, ten times, or twenty times in accordance with the display magnification change operation that is performed on the first input unit 2 by the user.

Furthermore, the bold solid line C2 indicates a higher value with an increase in the observation time during which the image of the same display area is continuously displayed, and the value is reset to zero if the display position is changed in accordance with the display position change operation that is performed on the first input unit 2 by the user. For example, as illustrated in FIG. 4, the coordinate values in both of the dashed line C3 (the X coordinate at the display position) and the dashed line C4 (the Y coordinate at the display position) are not changed in a period T1. In other words, in the period T1, the image of the same display area is continuously displayed. Therefore, as illustrated in FIG. 3, the bold solid line C2 indicates a high value in the period T1. Meanwhile, the same applies to periods T2 and T3. In particular, in the periods T2 and T3, the display magnification is increased to twenty times, which means that the user gazes at the image displayed by the display unit 3.

If it is determined that the observation termination operation is performed (Step S7: Yes), the processor 41 constantly monitors whether the selection condition input operation is performed on the first input unit 2 by the user (Step S8).

If it is determined that the selection condition input operation is performed (Step S8: Yes), the field of view information extraction unit 413 acquires a selection condition (display magnification) that is input through the selection condition input operation (Step S9).

After Step S9, the field of view information extraction unit 413 extracts pieces of field of view information including the magnification information corresponding to the selection condition (display magnification) that is acquired at Step S9 from among all pieces of the field of view information that are recorded in the field of view information recording unit 421 (Step S10).

After Step S10, the display control unit 414 generates field of view map images based on the pieces of field of view information that are extracted at Step S10 (Step S11).

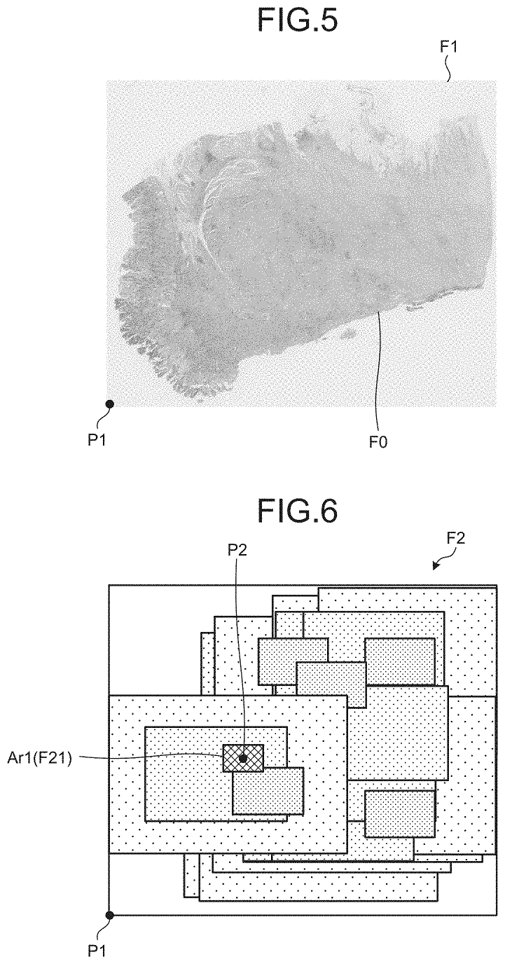

FIG. 5 and FIG. 6 are diagrams for explaining the field of view map images. Specifically, FIG. 5 illustrates a pathological specimen image F1. FIG. 6 illustrates field of view map images F2. Meanwhile, in FIG. 6, for convenience of explanation, all of the field of view map images (images with dot patterns in rectangular frames) F2 that are generated from all pieces of the field of view information recorded in the field of view information recording unit 421 are illustrated. Further, a point P1 illustrated in FIG. 5 and FIG. 6 indicates an origin for identifying the display position (X coordinate and Y coordinate) included in the field of view information.

Meanwhile, the field of view map images are obtained by quantifying states of observed field of views in accordance with the display magnification and the observation time and presenting the quantified state as images. Representative examples of the field of view map image include a heat map.

Specifically, at Step S11, the display control unit 414 generates the field of view map images F2 as described below.

The display control unit 414 generates the observation time during which an image corresponding to the field of view information is continuously displayed, based on the display position information and the time information that are included in the field of view information extracted at Step S10.

Here, it is assumed that field of view information on the period T2 illustrated in FIG. 3 and FIG. 4 is adopted. In the case of this field of view information, the display control unit 414 generates the observation time of 10 seconds.

Subsequently, the display control unit 414 generates the field of view map image F2 by creating an image of the observation time in the display area that is identified from the display position information and the magnification information that are included in the field of view information.

Here, in the examples illustrated in FIG. 3 and FIG. 4, it is assumed that the display position representing the display position information included in the field of view information on the period T2 corresponds to a display position P2 illustrated in FIG. 6. In this case, the display control unit 414 generates a field of view map image area F21 by creating an image of the observation time of 10 seconds in a display area Ar1 (FIG. 6) that is identified from the display position P2 and the display magnification of twenty times (FIG. 3) representing the magnification information included in the field of view information. In FIG. 6, the display area (rectangular frame) that is identified from the display position information and the magnification information that are included in the field of view information is reduced in size with an increase in the display magnification. Further, in the example in FIG. 6, the observation time is represented by an image with a dot pattern, and a density of the dot pattern is increased with an increase in the observation time. Meanwhile, a mode for representing the observation time by an image is not limited to the image of the dot pattern, but it may be possible to adopt what is called a heat map in which the observation time is represented by an image with a certain color.

Meanwhile, in a portion in which the display areas overlap with each other in each of the field of view map images F2, it may be possible to adopt a sum of the observation times or the longest observation time in this portion.

After Step S11, the processor 41 constantly monitors whether the display mode selection operation is performed on the first input unit 2 by the user (Step S12).

If it is determined that the display mode selection operation is performed (Step S12: Yes), the display control unit 414 determines whether the first display mode is selected as the display mode of the field of view map image through the display mode selection operation (Step S13).

If it is determined that the first display mode is selected (Step S13: Yes), the display control unit 414 controls operation of the display unit 3 and causes the display unit 3 to display, in the first display mode, the field of view map image that is generated at Step S11 (Step S14).

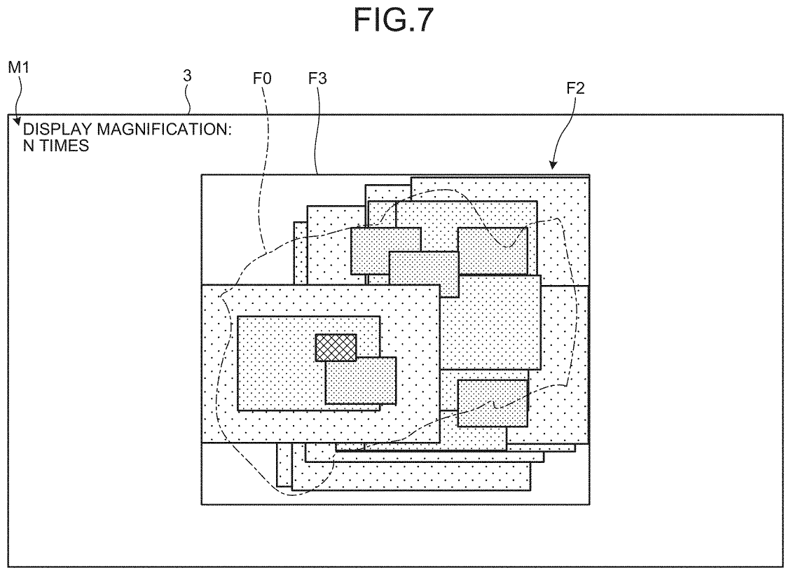

FIG. 7 is a diagram for explaining the first display mode. Specifically, FIG. 7 is a diagram corresponding to FIG. 5 and FIG. 6. In other words, in FIG. 7, for convenience of explanation, all of the field of view map images F2 that are generated from all pieces of the field of view information recorded in the field of view information recording unit 421 are illustrated similarly to FIG. 6. Meanwhile, in FIG. 7, for convenience of explanation, an object image (pathological specimen) F0 included in the pathological specimen image F1 is represented by a dashed line.

Specifically, at Step S14, the display control unit 414 causes the display unit 3 to display a superimposed image F3 in which the field of view map images F2 are superimposed on the pathological specimen image F1 as illustrated in FIG. 7. Further, the display control unit 414 causes the display unit 3 to display information M1 indicating a magnification corresponding to the selection condition (display magnification) that is acquired at Step S9. In this example, display of “display magnification: N times” is the information M1 indicating the magnification. The information M1 indicating the magnification may be displayed in a different method, such as by display of graphics or display of scales, as long as the display represents the selection condition (display magnification), apart from the display of characters.

In contrast, if it is determined that the second display mode is selected (Step S13: No), the display control unit 414 controls operation of the display unit 3 and causes the display unit 3 to display, in the second display mode, the field of view map image that is generated at Step S11 (Step S15).

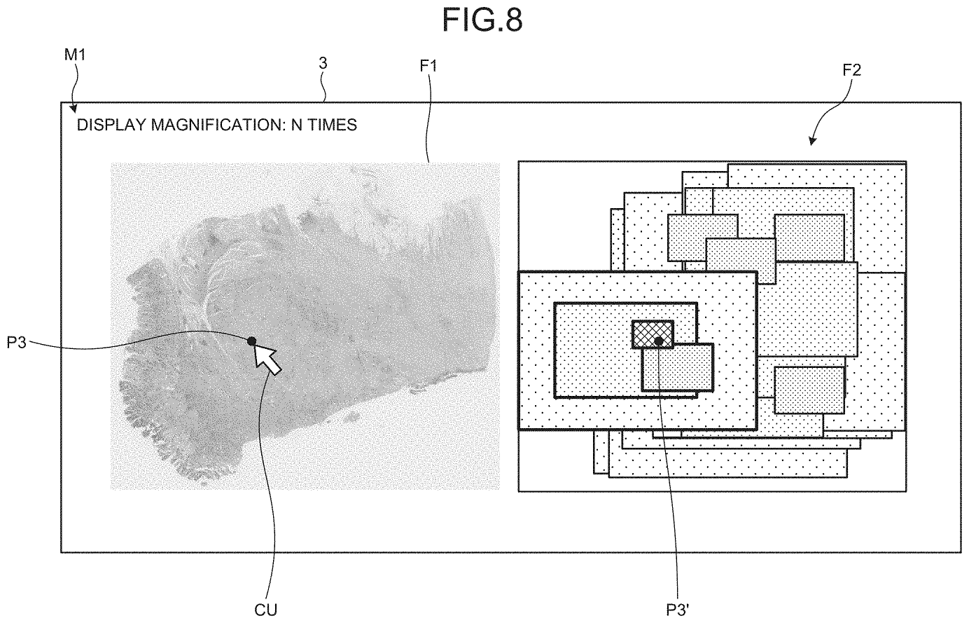

FIG. 8 is a diagram for explaining the second display mode. Specifically, FIG. 8 is a diagram corresponding to FIG. 5 and FIG. 6. In other words, in FIG. 8, for convenience of explanation, all of the field of view map images F2 that are generated from all pieces of the field of view information recorded in the field of view information recording unit 421 are illustrated similarly to FIG. 6.

Specifically, at Step S15, the display control unit 414 causes the display unit 3 to display the field of view map images F2 and the pathological specimen image F1 side by side as illustrated in FIG. 8. Further, the display control unit 414 causes the display unit 3 to display the information M1 indicating the magnification corresponding to the selection condition (display magnification) that is acquired at Step S9.

Here, the display control unit 414 displays the field of view map image F2 that is located at a position P3” corresponding to a position P3 indicated by a cursor CU on the pathological specimen image F1 such that the field of view map image F2 is distinguished from the other field of view map images F2, in accordance with user operation that is performed on the first input unit 2 by the user. In the example in FIG. 8, a contour of the frame of the field of view map image F2 located at the position P3′ is emphasized to distinguish the field of view map image F2 from the other field of view map images F2.

After Step S14 or Step S15, the processor 41 constantly monitors whether the selection condition (display magnification) is changed by the selection condition input operation that is performed on the first input unit 2 by the user (Step S16).

If it is determined that the selection condition is changed (Step S16: Yes), the processor 41 returns to Step S9. Further, the field of view information extraction unit 413 acquires the changed selection condition (display magnification). Thereafter, the process goes to Step S10.

In contrast, if it is determined that the selection condition is not changed (Step S16: No), the processor 41 terminates the control flow.

According to the first embodiment as described above, it is possible to achieve the effects as described below.

The information processing apparatus 4 according to the first embodiment generates the field of view information, and visualizes, as the field of view map image, an observation state that indicates the position and the way of observation of the pathological specimen image, based on the field of view information. Therefore, it is possible to display the field of view map image in accordance with a type of a lesion in diagnosis, so that it is possible to perform diagnosis support, such as sharing of the diagnosis among pathologists or prevention of omission of an important lesion site by double checking, in a convenient manner. Further, by displaying the field of view map image in the first display mode in which the field of view map image is superimposed on the pathological specimen image, it is possible to easily recognize an area that is paid attention to in actual observation, so that it is possible to support improvement in accuracy of the diagnosis performed by the pathologist. In contrast, by displaying the field of view map image in the second display mode in which the field of view map image and the pathological specimen image are arranged side by side, it is possible to easily recognize the area that is paid attention to while keeping displaying the state of the pathological specimen image, so that it is possible to support improvement in accuracy of the diagnosis performed by the pathologist similarly to the above.

In particular, the user is able to display only the field of view map image with a certain display magnification by performing input operation (selection condition input operation) for inputting the selection condition (display magnification) in the first input unit 2.

Therefore, by comparison between the field of view map image with a low display magnification and the field of view map image with a high display magnification, it is possible to recognize that a portion of interest in the observation with the low magnification is further observed with the increased magnification, for example. More specifically, if the observation time with the low display magnification is relatively short, but the observation time with the high display magnification is increased, it is assumed that the observation is performed over time by enlarging the image and fixing the position of the image. In contrast, if the observation time with the low display magnification is relatively long, but the observation time with the high display magnification is relatively short, it is assumed that the observation is performed over time with the low magnification, but the observation time with the high magnification is reduced.

### Second Embodiment

A second embodiment will be described below.

In the description below, the same components as those of the first embodiment as described above are denoted by the same reference symbols, and detailed explanation thereof will be omitted or simplified.

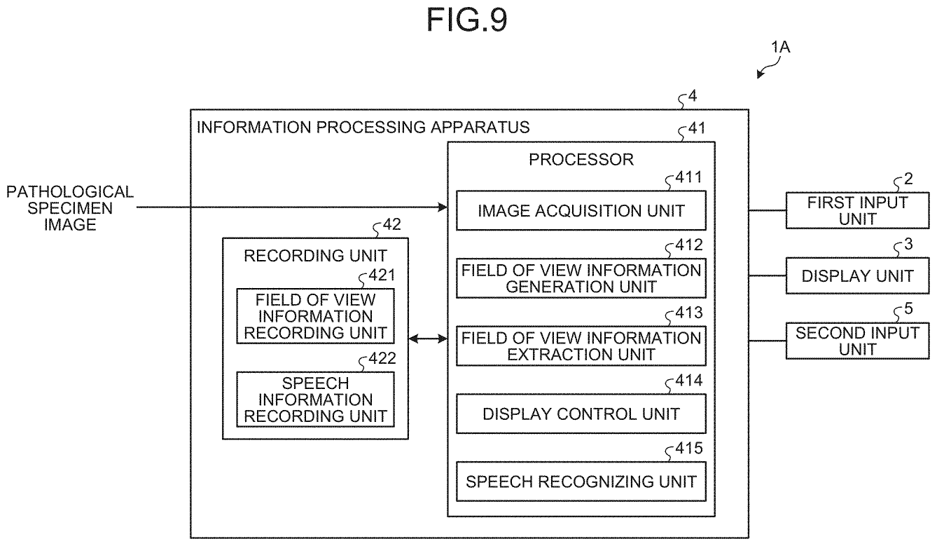

FIG. 9 is a block diagram illustrating an information processing system 1A according to the second embodiment.

In the information processing system 1A according to the second embodiment, words spoken by a user is used to extract the field of view information. Further, in the information processing system 1A, as illustrated in FIG. 9, a second input unit 5 is added to the information processing system 1 that is explained in the first embodiment as described above (FIG. 1). Furthermore, in the information processing system 1A, a speech recognizing unit 415 is added to the processor 41, and a speech information recording unit 422 is added to the recording unit 42.

The second input unit 5 corresponds to the input unit according to the present disclosure. The second input unit 5 includes a microphone that converts an input speech into an electrical signal, and a speech processing unit that generates a speech signal (digital signal) by performing analog-to-digital (A/D) conversion on the electrical signal, although specific illustration of these units are omitted. Further, the second input unit 5 outputs the speech signal corresponding to the input speech to the information processing apparatus 4.

Meanwhile, functions of the speech recognizing unit 415 will be described in the following description of an information processing method according to the second embodiment.

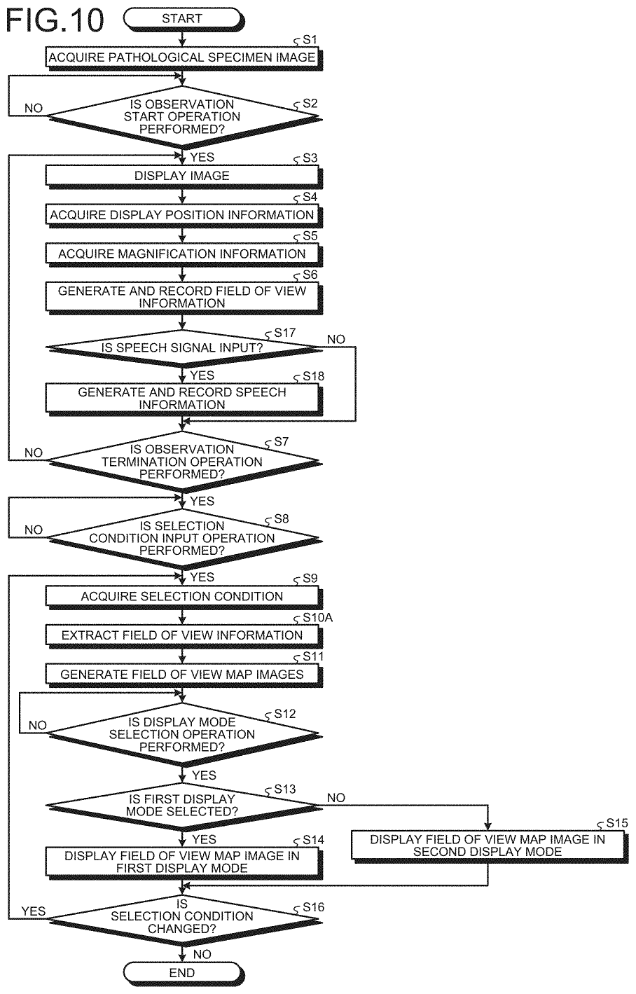

FIG. 10 is a flowchart illustrating the information processing method.

As illustrated in FIG. 10, the information processing method according to the second embodiment is different from the information processing method of the first embodiment described above (FIG. 2) in that Steps S17 and S18 are added and Step S10A is added instead of Step S10. Therefore, only Steps S17, S18, and S10A will be mainly described below.

Step S17 is performed after Step S6.

Specifically, at Step S17, the processor 41 determines whether the speech signal is input from the second input unit 5.

If it is determined that the speech signal is not input (Step S17: No), the processor 41 goes to Step S7.

In contrast, if it is determined that the speech signal is input (Step S17: Yes), the speech recognizing unit 415 converts a speech corresponding to the speech signal into textural information that represents the speech by words based on the speech signal. Further, the speech recognizing unit 415 generates speech information in which a time at which the input of the speech signal is started (hereinafter, described as an utterance start time) and a time at which the input of the speech signal is terminated (hereinafter, described as an utterance end time) is associated with the textual information, and records the speech information in the speech information recording unit 422 (Step S18). Thereafter, the processor 41 goes to Step S7.

Then, Step S10A is performed as described below.

Specifically, the field of view information extraction unit 413 recognizes the selection condition (display magnification) that is acquired at Step S9 and the utterance start time and the utterance end time that are included in the specific speech information that is recorded at Step S18. Further, the field of view information extraction unit 413 extracts pieces of field of view information that include the magnification information corresponding to the selection condition (display magnification) and the time information indicating a display time from the utterance start time to the utterance end time from among all pieces of the field of view information that are recorded in the field of view information recording unit 421. The time from the utterance start time to the utterance end time corresponds to a specific time according to the present disclosure.

Meanwhile, the “specific speech information” described above indicates speech information including the textual information on a specific keyword, such as a cancer.

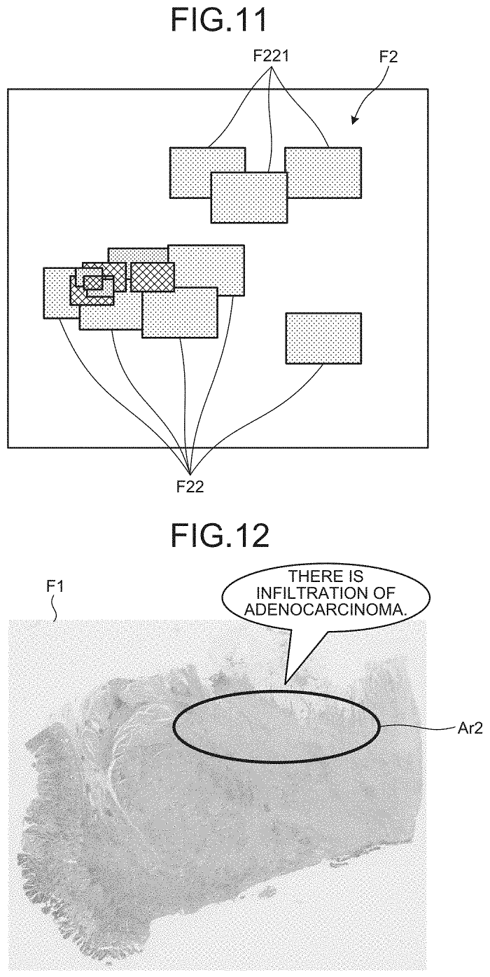

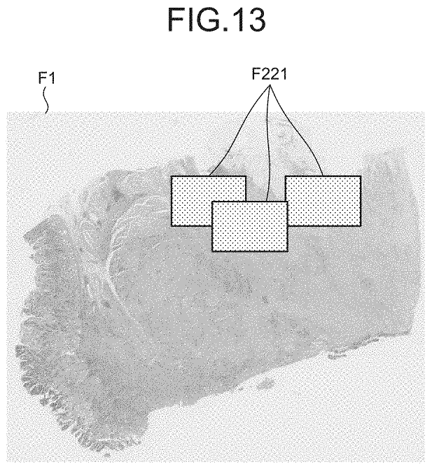

FIG. 11 to FIG. 13 are diagrams for explaining Step S10A. Specifically, FIG. 11 illustrates all of the field of view map images F2 that are generated from all pieces of the field of view information recorded in the field of view information recording unit 421. FIG. 12 illustrates the pathological specimen image F1. FIG. 13 illustrates field of view map image areas F221 corresponding to the pieces of field of view information that are extracted at Step S10A.

Here, it is assumed that a user who is observing a display area Ar2 in the loop from Step S3 to Steps S6, 317, and S18 speaks words of “there is infiltration of adenocarcinoma” (FIG. 12). Further, it is assumed that the selection condition (display magnification) acquired at Step S9 indicates “two times”.

In this case, each of field of view map image areas F22 (FIG. 11) is a field of view map image corresponding to the field of view information that includes the magnification information indicating the display magnification of two times among all pieces of the field of view information (the field of view map images F2) that are recorded in the field of view information recording unit 421. Further, each of the field of view map image areas F221 (FIG. 11) is a field of view map image corresponding to the field of view information that includes the time information indicating the display time from the utterance start time to the utterance end time that is a time in which the user speaks the words of “there is infiltration of adenocarcinoma”. Therefore, at Step S10A, as illustrated in FIG. 13, piece of the field of view information (the field of view map image areas F221) are extracted.

According to the second embodiment as described above, it is possible to achieve the effects as described below, in addition to the same effects as those of the first embodiment as described above.

According to the information processing apparatus 4 of the second embodiment, it is possible to identify a time in which certain operation is performed, by chronologically recording contents of operation, such as speech input, that is performed by a user. In other words, by combining the time in which the certain operation is performed and the display magnification, it is possible to display a state of a field of view that is adopted by the user during the certain operation and visualize the state of a diagnosis to allow easy understanding of the diagnosis, so that it is possible to support improvement in accuracy of the diagnosis performed by the pathologist.

### Third Embodiment

A third embodiment will be described below.

In the description below, the same components as those of the first embodiment as described above are denoted by the same reference symbols, and detailed explanation thereof will be omitted or simplified.

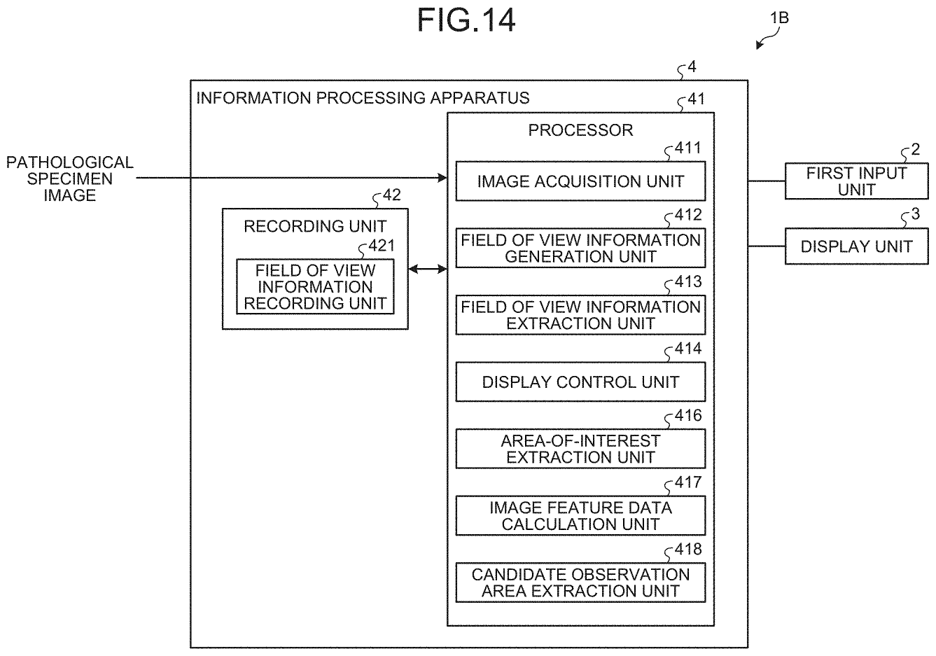

FIG. 14 is a block diagram illustrating an information processing system 1B according to the third embodiment.

In the information processing system 1B according to the third embodiment, a field of view map image is generated based on an area of interest that is gazed at by a user at the time of observation of the pathological specimen image F1 and based on field of view information corresponding to a candidate observation area having image feature data that is similar to that of the area of interest. Further, as illustrated in FIG. 14, in the information processing system 1B, an area-of-interest extraction unit 416, an image feature data calculation unit 417, and a candidate observation area extraction unit 418 are added to the processor 41 in the information processing system 1 (FIG. 1) that is explained in the first embodiment as described above.

Meanwhile, functions of the area-of-interest extraction unit 416, the image feature data calculation unit 417, and the candidate observation area extraction unit 418 will be described in the following description of an information processing method according to the third embodiment.

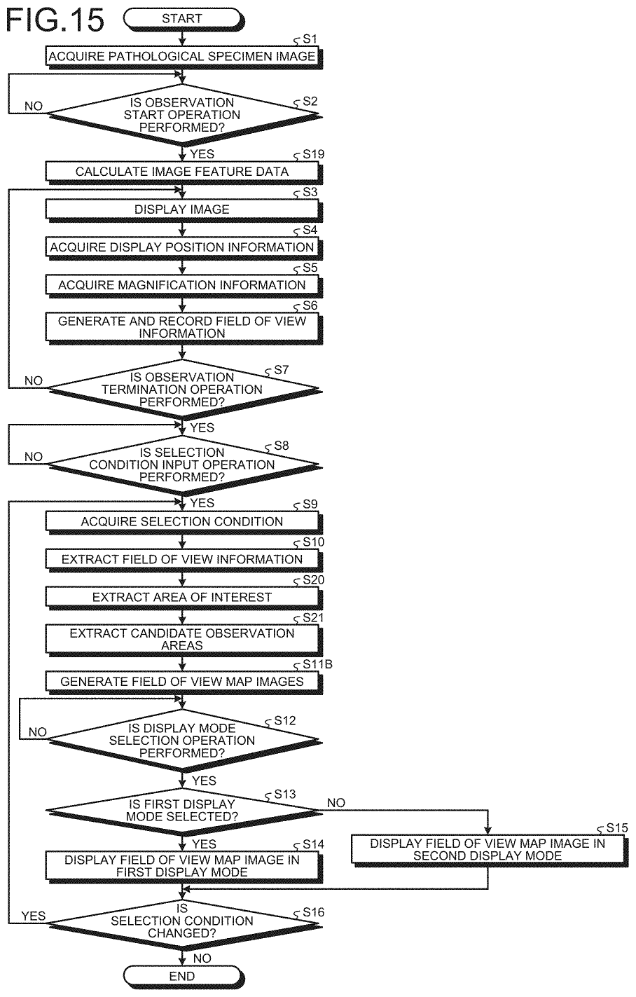

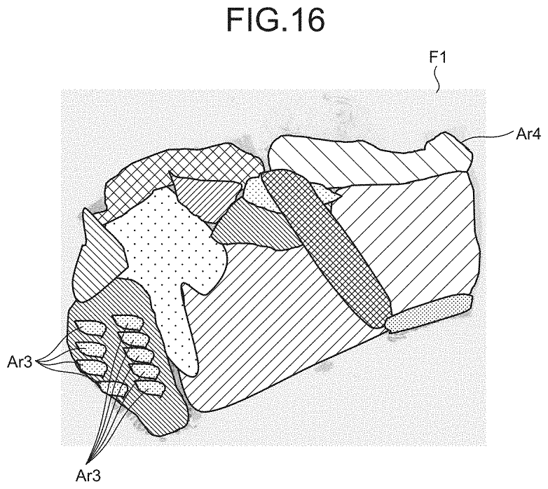

FIG. 15 is a flowchart illustrating the information processing method.

As illustrated in FIG. 15, the information processing method according to the third embodiment is different from the information processing method according to the first embodiment described above (FIG. 2) in that Steps S19 to S21 are added and Step S11B is added instead of Step S11. Therefore, only Steps S19 to S21 and S11B will be mainly described below.

Step S19 is performed if it is determined that the observation start operation is performed (Step S2: Yes).

FIG. 16 is a diagram for explaining Step S19.

Specifically, at Step S19, the image feature data calculation unit 417 calculates image feature data for each of unit areas (for examples, pixels or the like) in the entire pathological specimen image F1. Meanwhile, in FIG. 16, areas with similar image feature data are represented by the same pattern. For example, areas Ar3 are areas with similar image feature data. Further, an area Ar4 is an area with similar image feature data.

Here, the image feature data is, for example, image feature data composed of a spatial component, such as an edge or texture, image feature data composed of a frequency component, such as luminance unevenness, or image feature data composed of a color component, such as hue or saturation, and is a single kind of image feature data or a combination of a plurality of kinds of image feature data.

Step S20 is performed after Step S10.

Specifically, the area-of-interest extraction unit 416 generates an observation time during which an image corresponding to the field of view information is continuously displayed, based on the display position information and the time information that are included in the pieces of field of view information extracted at Step S10. Further, the area-of-interest extraction unit 416 extracts, as an area of interest, a piece of field of view information for which the generated observation time is equal to or larger than a predetermined time among the pieces of field of view information extracted at Step S10 (Step S20).

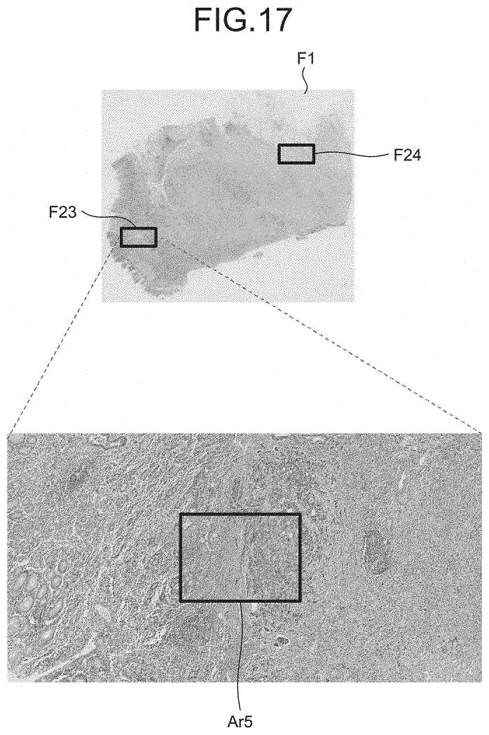

FIG. 17 is a diagram for explaining Step S20.

Here, it is assumed that two pieces of field of view information corresponding to the periods T2 and T3 illustrated in FIG. 3 and FIG. 4 are extracted at Step S10, in other words, it is assumed that the selection condition (display magnification) acquired at Step S9 indicates “twenty times”. Further, it is assumed that the predetermined time period as described above is “10 seconds”. In this case, each of observation times that are generated from the two pieces of field of view information corresponding to the periods T2 and T3 is equal to or larger than 10 seconds, and therefore, the area-of-interest extraction unit 416 adopts both of the two pieces of field of view information extracted at Step S10 as the areas of interest (Step S20). FIG. 17 illustrates field of view map image areas F23 and F24 corresponding to the two areas of interest (field of view information). Meanwhile, in FIG. 17, for convenience of explanation, dot patterns corresponding to the observation times are not added to the field of view map image areas F23 and F24.

After Step S20, the candidate observation area extraction unit 418 extracts candidate observation areas (Step S21).

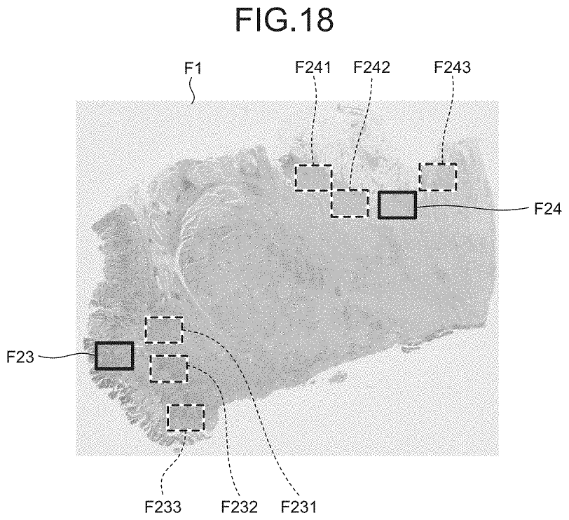

FIG. 18 is a diagram for explaining Step S21. FIG. 18 is a diagram corresponding to FIG. 17.

Specifically, the candidate observation area extraction unit 418 refers to the image feature data that is calculated at Step S19, and recognizes the image feature data of the areas of interest that are extracted at Step S20. Further, the candidate observation area extraction unit 418 refers to the image feature data that is calculated at Step S19, and recognizes the image feature data of the same field of view as the area of interest based on the magnification information. Then, the candidate observation area extraction unit 418 extracts, as the candidate observation areas, areas with the image feature data similar to the image feature data of the area of interest (Step S21). FIG. 18 illustrates field of view map image areas F231 to F233 corresponding to the candidate observation areas that have image feature data similar to the image feature data of a single area of interest (field of view map image area F23), and field of view map image areas F241 to F243 corresponding to the candidate observation areas that have image feature data similar to the image feature data of a single area of interest (field of view map image area F24). The field of view map image areas F23 and F231 to F233 are field of view map images that are located in the area Ar3 illustrated in FIG. 16. Further, the field of view map image areas F24 and F241 to F243 are field of view map images that are located in the area Ar4 illustrated in FIG. 16. Meanwhile, in FIG. 18, for convenience of explanation, dot patterns corresponding to the observation times are not added to the field of view map image areas F231 to F233 and F241 to F243, similarly to the field of view map image areas F23 and F24.

Meanwhile, it may be possible to extract the candidate observation areas by using image feature data of the entire area of interest as the image feature data of the area of interest, or it may be possible to extract the candidate observation areas by using a partial area (for example, a central area Ar5 illustrated in FIG. 17) of the area of interest. Further, it may be possible to extract, as the candidate observation areas, only areas with the same display magnification (the selection condition acquired at Step S9) as the area of interest.

Furthermore, various methods have been proposed for extracting the candidate observation areas that are similar to the image feature data of the area of interest. For example, in the literature of “https://www.semanticscholar.org/paper/A-Cluster-then-label-Semi-supervised-Learning-for-Peikari-Salama/33fa30639e30bfa85fed7aeb3ald5e536b9435f3”, a method of classifying a lesion by using T-distributed stochastic neighbor embedding (t-SNE) for visualization by compressing high-dimensional data of a pathological image to two-dimensional or three-dimensional data is discussed, and it may be possible to extract the candidate observation areas by using the method as described above.

After Step S21, the display control unit 414 generates a field of view map image of each of the areas of interest (field of view information) that are extracted at Step S20 and field of view map images of the candidate observation areas (field of view information) that are extracted at Step S21 (Step S11B). Further, at Step S14, as illustrated in FIG. 18 for example, the field of view map image areas F23, F231 to F233, F24, and F241 to F243 are displayed on the display unit 3 in a superimposed manner on the pathological specimen image F1. Meanwhile, in this display, the field of view map image areas F23 and F231 to F233 and the field of view map image areas F24 and F241 to F243 may be displayed in a distinguishable manner. Further, to distinguish between the areas of interest and the candidate observation areas, for example, the field of view map image area F23 (F24) and the field of view map image areas F231 to F233 (F241 to F243) may be displayed in a distinguishable manner.

According to the third embodiment as described above, it is possible to achieve the effects as described below, in addition to the same effects as those of the first embodiment as described above.

The information processing apparatus 4 according to the third embodiment adopts, as the area of interest, a piece of field of view information with a specific display magnification and a long observation time among all pieces of the field of view information that are recorded in the field of view information recording unit 421. Further, the information processing apparatus 4 extracts, as the candidate observation areas, similar areas in the pathological specimen image from the viewpoint of the image feature data of the area of interest. Furthermore, the information processing apparatus 4 visualizes the area of interest and the candidate observation areas as the field of view map images. Therefore, it is possible to provide the candidate sites of a lesion similar to a portion that was observed in the past to an observer, such as a pathologist. Moreover, by comparison between the image feature data associated with the field of view information obtained by observation of the past pathological specimen image and the image feature data in the current pathological specimen image, it is possible to extract, from the current pathological specimen image, an area that is similar to the image feature data that was paid attention to in the past pathological specimen image, so that it is possible to perform diagnosis support, such as detection of a missing lesion of interest and prevention of omission of a lesion of interest.

### Fourth Embodiment

A Fourth Embodiment Will be Described Below.

In the description below, the same components as those of the first embodiment as described above are denoted by the same reference symbols, and detailed explanation thereof will be omitted or simplified.

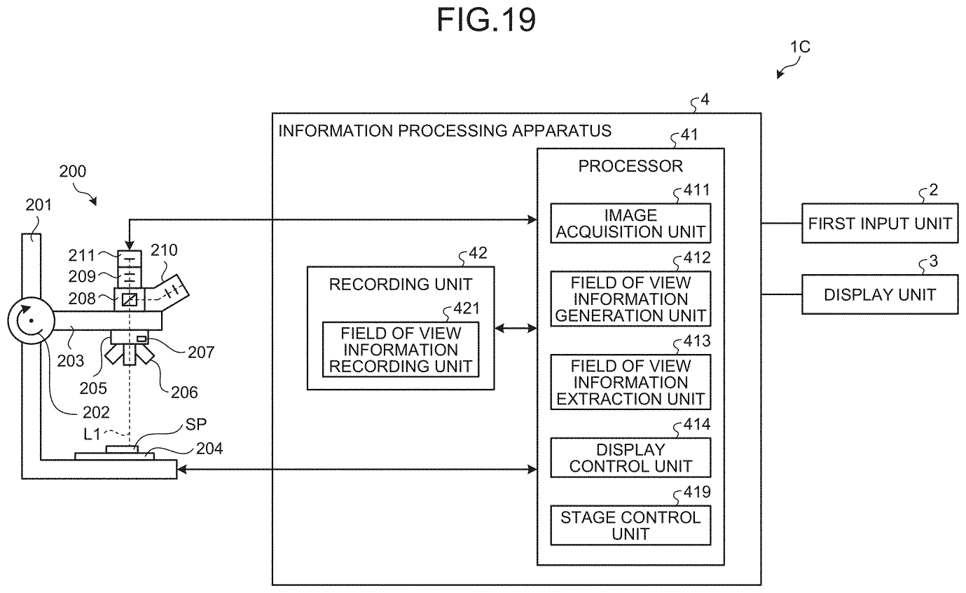

FIG. 19 is a block diagram illustrating a microscope system 1C according to the fourth embodiment.

In the first embodiment as described above, the pathological specimen image F1 acquired by the information processing apparatus 4 is a virtual slide image.

In contrast, in the microscope system 1C according to the fourth embodiment, the information processing apparatus 4 acquires an image (pathological specimen image) that is captured by a microscope 200 in real time. Further, as illustrated in FIG. 19, in the microscope system 1C, the microscope 200 is added to the information processing system 1 of the first embodiment as described above, and a stage control unit 419 is added to the processor 41.

The microscope 200 includes a main body 201, a rotation unit 202, a lifting unit 203, a stage 204, a revolver 205, objective lenses 206, a magnification detection unit 207, a lens barrel 208, a connection unit 209, an eyepiece portion 210, and an imaging unit 211.

As illustrated in FIG. 19, the main body 201 has an L-shape when viewed from side and supports each of the members 202 to 211.

The lifting unit 203 is connected to the main body 201 so as to be freely movable in the vertical direction.

The rotation unit 202 rotates in accordance with user operation and moves the lifting unit 203 in the vertical direction.

As illustrated in FIG. 19, the stage 204 is a portion on which a pathological specimen SP is placed. The stage 204 faces the lifting unit 203 from a lower side, and is connected to the main body 201 so as to be movable in a horizontal plane. Further, a field of view is changed with movement of the stage 204. Meanwhile, the movement of the stage 204 is performed in accordance with the display position change operation that is performed on the first input unit 2 by the user, under the control of a stage control unit 419.

Here, the display position information in the fourth embodiment is information indicating a position (X coordinate and Y coordinate) of the stage 204.

As illustrated in FIG. 19, the plurality of objective lenses 206 with different magnifications are connected to the revolver 205. Further, the revolver 205 is connected to a lower surface of the lifting unit 203 so as to be rotatable about an optical axis L1. The user arranges a desired one of the objective lenses on the optical axis L1 by operating the revolver 205.

Here, information indicating the magnification, such as an IC chip, is attached to each of the objective lenses 206.

Further, the magnification detection unit 207 detects the magnification of the objective lens 206 from the IC chip or the like that is attached to the objective lens 206 arranged on the optical axis Ll. Furthermore, the magnification detection unit 207 outputs the detected information indicating the magnification to the information processing apparatus 4.

Here, the magnification information according to the fourth embodiment is information indicating an integrated magnification of the magnification of the objective lens 206 that is arranged on the optical axis L1 and a magnification of the eyepiece portion 210 (eyepiece).

The lens barrel 208 includes, inside thereof, a prism, a half mirror, a collimator lens, and the like. Further, the lens barrel 208 transmits a part of an object image of the pathological specimen SP that is formed on the objective lens 206 toward the connection unit 209 and reflects the part of the object image toward the eyepiece portion 210.

The connection unit 209 is configured with a plurality of collimator lenses, a tube lens, and the like. One end of the connection unit 209 is connected to the lens barrel 208, and the other end is connected to the imaging unit 211. Further, the connection unit 209 guides light of the object image of the pathological specimen SP that has transmitted through the lens barrel 208 toward the imaging unit 211.

The eyepiece portion 210 is configured with a plurality of collimator lenses, a tube lens, and the like. Further, the eyepiece portion 210 guides light of the object image reflected by the lens barrel 208 and forms the object image.

The imaging unit 211 is configured with an image sensor, such as a complementary metal oxide semiconductor (CMOS) or a charge coupled device (CCD). Further, the imaging unit 211 generates image data (corresponding to a pathological specimen image according to the present disclosure) by receiving the light of the object image of the pathological specimen SP formed by the connection unit 209, and outputs the image data to the information processing apparatus 4.

Meanwhile, the fourth embodiment is different from the first embodiment as described above only in terms of the pathological specimen image, the display position information, and the magnification information to be acquired. Therefore, an information processing method according to the fourth embodiment is the same as the information processing method of the first embodiment described above (FIG. 2).

Even with the microscope system 1C according to the fourth embodiment as described above, it is possible to achieve the same effects as those of the first embodiment as described above.

### Other Embodiments

While the embodiments of the present disclosure have been described above, the present disclosure is not limited to only the first to the fourth embodiments as described above.

The configurations described in the second to the fourth embodiments as described above may be combined appropriately. For example, it may be possible to add the area-of-interest extraction unit 416, the image feature data calculation unit 417, and the candidate observation area extraction unit 418 to the information processing system 1A of the second embodiment to perform the processes at Steps S19 to S21 and S11B.

In the first to the fourth embodiments as described above, the sequences of the processes in the flowcharts illustrated in FIG. 2, FIG. 10, and FIG. 15 may be changed as long as there is no contradiction.

According to the information processing apparatus, the information processing method, and the information processing program of the present disclosure, it is possible to perform diagnosis support in a convenient manner.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising
a processor comprising hardware, the processor being configured to:
control a display to display at least a partial image of a captured image generated by capturing an image of an observation target;
generate field of view information by associating: display position information indicating a position of a display area corresponding to the displayed partial image; magnification information indicating a display magnification of the partial image; and time information indicating a display time of the partial image;
record the field of view information in a memory; and
extract a piece of the field of view information including the magnification information indicating at least a single kind of specific display magnification input to an input device from among pieces of the field of view information recorded in the memory;
generate a field of view map image corresponding to the extracted piece of field of view information; and
control the display to display the field of view map image.

2. The information processing apparatus according to claim 1, wherein the processor is configured to control the display to display a superimposed image in which the field of view map image is superimposed on the captured image.

3. The information processing apparatus according to claim 1, wherein the display control unit causes the display unit to display the field of view map image and the captured image side by side.

4. The information processing apparatus according to claim 2, wherein the processor is configured to control the display to display information indicating a magnification corresponding to the magnification information indicating the specific display magnification.

5. The information processing apparatus according to claim 2, wherein the processor is configured to
generate an observation time during which the partial image is continuously displayed based on the display position information and the time information that are included in the field of view information, and
generate the field of view map image in which the observation time is represented by an image in the display area identified from the display position information and the magnification information that are included in the field of view information.

6. The information processing apparatus according to claim 1, wherein the processor is configured to extract the piece of field of view information identified from, as an extraction condition, the magnification information indicating the specific display magnification and observation time information that is based on a display time in specific duration, from among the pieces of field of view information that are recorded in the memory.

7. The information processing apparatus according to claim 6, wherein the processor is configured to generate the specific duration based on a timing at which specific information is input to the input device.

8. The information processing apparatus according to claim 1, wherein the processor is configured to:
extract an area of interest in the captured image based on the field of view information;
calculate image feature data of each of areas in the captured image; and
extract, in the captured image, a candidate observation area that has image feature data similar to the image feature data of the area of interest.

9. A method of processing information, comprising:
displaying at least a partial image of a captured image generated by capturing an image of an observation target;
generating field of view information by associating: display position information indicating a position of a display area corresponding to the displayed partial image;
magnification information indicating a display magnification of the partial image; and time information indicating a display time of the partial image;
recording the field of view information in a memory; and
extracting a piece of the field of view information including the magnification information indicating at least a single kind of specific display magnification input to an input device from among pieces of the field of view information recorded in the memory;
generating a field of view map image corresponding to the extracted piece of field of view information; and
displaying the field of view map image.

10. A non-transitory computer-readable recording medium on which an executable program is recorded, the program causing a processor of a computer to execute:
controlling a display to display at least a partial image of a captured image generated by capturing an image of an observation target;
generating field of view information by associating:
display position information indicating a position of a display area corresponding to the displayed partial image;
magnification information indicating a display magnification of the partial image; and time information indicating a display time of the partial image;
recording the field of view information in a memory; and
extracting a piece of the field of view information including the magnification information indicating at least a single kind of specific display magnification input to an input device from among pieces of the field of view information recorded in the memory;
generating a field of view map image corresponding to the extracted piece of field of view information; and
controlling the display to display the field of view map image.
